(19) United States
(12) Patent Application Publication
(10) Pub. No.: US 2025/0348787 A1
(43) Pub. Date: Nov. 13, 2025

(54) DISTRIBUTED SYSTEMS FOR FEDERATED MACHINE LEARNING TECHNIQUES IN ANOMALY DETECTION

(71) Applicant: Consilient Inc., Washington, DC (US)

(72) Inventor: Ajit Tharaken, Washington, DC (US)

(21) Appl. No.: 19/205,293

(22) Filed: May 12, 2025

Related U.S. Application Data
(60) Provisional application No. 63/645,700, filed on May 10, 2024.

(51) Int. Cl. G06N 20/00

(52) U.S. Cl. CPC G06N 20/00

(57) ABSTRACT

Systems and methods are described herein for generating, training, and federating machine learning models to detect anomalous or rare-event activity in sensitive electronic data, such as financial transactions. In some implementations, configuration information for a machine learning script (MLS) is obtained. The MLS is generated by a server based on the configuration. Data representing the MLS is provided to a user device. The user device is caused to perform operations when executing the MLS. An instance of a machine learning model is trained based on the MLS. One or more parameters associated with the instance of the machine learning model are identified. Data representing the one or more parameters associated with the instance of the machine learning model are received by the server from the user. A federated model is generated based at least in part on the received data representing the identified parameters and provided for output.

### CROSS-REFERENCE TO RELATED APPLICATIONS

This application claims the benefit of U.S. Application Ser. No. 63/645,700, filed May 10, 2024, which is incorporated herein by reference in its entirety.

### TECHNICAL FIELD

This specification generally relates to machine learning, and more particularly, to computing systems for federated machine learning using distributed model training and aggregation.

### BACKGROUND

Federated machine learning is an approach to training machine learning models across multiple decentralized devices or servers holding local data samples, without exchanging the raw data itself. In this paradigm, each participating node trains a local model on its own dataset, and model updates or parameters are shared with a central server. A server aggregates these updates to improve a global model. Some potential applications of federated learning techniques include mobile keyboard prediction, healthcare analytics across multiple hospitals, and financial fraud detection across different institutions, where data sharing is restricted due to privacy regulations or competitive concerns.

In the context of transaction processing systems, federated machine learning can be used to improve the detection of fraudulent or anomalous transactions across multiple financial institutions. Federated learning may also be applicable to optimize credit scoring models, where lenders can collaboratively improve the accuracy of credit risk predictions without exchanging proprietary customer or portfolio data. Other applications may include real-time risk assessment for cross-border payments, adaptive anti-money laundering (AML) models, and dynamic pricing algorithms that adjust to transaction patterns while preserving regulatory compliance and data sovereignty.

### SUMMARY

This disclosure describes systems and methods for generating, training, and federating machine learning models to detect anomalous or rare-event activity in sensitive electronic data, such as financial transactions. Authenticated client devices access model training scripts (MTS) from a server and use them locally to train models on proprietary or private data, including financial or health information, without transferring the raw data off the device. To address technical challenges posed by data privacy laws, banking regulations, and confidentiality agreements, the systems disclosed herein may leverage federated learning techniques that aggregate locally trained models (LTMs) across multiple client devices into a federated champion model on the server, thereby improving anomaly detection while preserving data privacy. This approach enables effective model training across distributed datasets without centralizing sensitive data, reducing the need for anonymization or data sharing, and increasing detection accuracy across varied data sources.

For example, the systems and methods may include one or more authenticated and authorized client devices having permissions to access a centralized server. The client device, having the requisite authorization, is granted access to a set of artificial intelligence model training scripts hosted on the server.

To improve the effectiveness, efficiency, and discovery of models, training may be based on diverse data which usually is private, protected, and available across multiple organizations and jurisdictions. To train such models, data may be aggregated in one location. However, data privacy laws, banking regulations, and contractual and confidentiality agreements may prevent financial institutions from sharing data for model training. This disclosure describes systems and techniques that address these technical problems by implementing solutions rooted in computer technology, including artificial intelligence.

The systems and techniques disclosed herein address technical challenges associated with training machine learning models on sensitive and distributed datasets without violating privacy regulations or requiring data centralization. Some training approaches involve aggregating raw data from multiple sources into a central repository, which may pose significant technical barriers due to data privacy laws, banking regulations, and confidentiality obligations. The techniques disclosed herein overcome these technical limitations by leveraging a distributed computing architecture in which authenticated client devices locally execute MTS using private or proprietary data stored on their own hardware. The system may also enable LTMs and relies on specialized server software to federate these models into a global, or federated model. This improves the accuracy and generalizability of anomaly detection systems without requiring the raw data to be transferred, copied, or stored outside the originating client device.

Importantly, the systems and techniques disclosed herein improve the functionality of distributed computer systems and networks through use of federated learning to orchestrate the local training of models across multiple authenticated client devices. In such environments, each client device operates on sensitive or regulated datasets, creating challenges unique to the computer domain. The system architecture disclosed herein solves technical problems implicated by these network environments by, for example, reducing bandwidth consumption, overcoming data localization barriers, preserving data integrity, and ensuring compliance with privacy and security regulations. The architecture further enables coordinated model aggregation without transmitting the underlying data, improving the scalability, reliability, and privacy-preserving capabilities of machine learning operations across heterogeneous computing environments. As a result, the systems and techniques improve both the technical infrastructure and the quality of anomaly detection outcomes.

In some examples, a system includes an originating client device (e.g., contributing device) that is authenticated and authorized to have access (e.g., by having a valid subscription) to a centralized server enabling processing of MTS. The system may be configured to cause the server to make MTS available on a hosting client device (e.g., user device). The user device has access to proprietary and/or private data hosted in one or more memory devices. The user device uses the downloaded MTS to generate a model locally. Once generated at the user device, the model is trained using private or proprietary data of the user device. For instance, the private/proprietary data may be financial transactions or health data, including text files, documents, and images from a set of specific user account at an investment or retail bank. In other instances, differential privacy can provide a strong guarantee of privacy by allowing data to be analyzed without revealing any data that the models use to trains on. Differential privacy may be implemented as mathematical or algorithmic framework that enables disclosed system to ensure the privacy of data in different datasets.

In some implementations, differential privacy (DP) is leveraged to ensure the privacy of data in different datasets. DP may be applied at various stages within the example shown in FIG. 1. For instance, DP mechanisms may be integrated into the local training process (e.g., process 4C in FIG. 1) on the user device 130. This may involve employing techniques such as Differentially Private Stochastic Gradient Descent (DP-SGD), where calibrated noise (e.g., Gaussian or Laplacian noise) is added to the gradients of the model parameters during local training on local data 132 before the LTM (e . . . , parameter data 106, LTMs 208A-C) is finalized and transmitted to the server 110. This ensures that the shared LTMs are themselves differentially private, formally limiting what can be inferred about any individual data point within the local data 132. The server 110 may also apply DP mechanisms during the aggregation of LTMs or during the generation of the synthetic dataset 112 from LTMs to provide an additional layer of privacy. The management of a privacy budget (e.g., epsilon values) across multiple training rounds or contributions from a single user device can be implemented to control cumulative privacy loss.

In some implementations, the MTS includes an instruction to generate the model at the user device, as well as instructions on the type of data or data criteria used by the instructions to train the MTS. For example, the type or criteria of data may include aggregating data by date or age range. Individual demographics, geographic information, and/or health-related data may be used as another criteria, in other implementations. The criteria may include numeric values related to number of transactions, one or more transaction values, currencies, among other criteria.

The output, from the user device trained on the specified data is a local trained model (“LTM”). Neither the LTM, contributor device, or server store, retain, or copy the locally trained data at the user device. The MTS maybe trained at multiple hosting clients, each having their own local data. LTMs generated at each hosting client are transmitted from the user device back to the server. The server includes additional software, which federates the LTM into a new “champion” model. Advantageously, this new federated champion model includes the learning and training obtained from multiple client device data without copying, storing, or transferring, or otherwise retaining the data. Moreover, the system and techniques obviate the need to anonymize the data before training, since the data remains with the originating user device and is not retained by the server. This new federated model is indexed and stored by type on the server can then be downloaded to the contributor or user devices. The method and techniques herein described increase the probability of detecting anomalies in electronic transaction data, specifically the detection of rare events.

The details of one or more implementations are set forth in the accompanying drawings and the description below. Other potential features and advantages will become apparent from the description, the drawings, and the claims.

### BRIEF DESCRIPTION OF THE DRAWINGS

FIG. 1 illustrates an example of a system having a server coupled to a user device configured to federate one or more artificial intelligence models.

FIG. 2 illustrates an example of a system a server coupled to plural user devices configured to federate one or more artificial intelligence models.

FIG. 3 is a flow chart illustrating an exemplary method of generating a federated artificial intelligence model.

### DETAILED DESCRIPTION

In general, systems and methods are described for generating, training, and federating machine learning models to detect anomalous or rare-event activity in sensitive electronic data, such as financial transactions. Authenticated client devices locally execute MTS on proprietary data without transferring raw data off-device. To address technical challenges posed by privacy laws and confidentiality obligations, the system leverages federated learning to aggregate LTMs into a federated champion model on the server, improving anomaly detection while preserving data privacy. This enables effective model training across distributed datasets without centralizing sensitive data, reducing the need for anonymization, and enhancing detection accuracy.

As described herein, “machine learning” refers to a class of computational techniques and models, including to neural networks, transformer-based architectures, generative artificial intelligence, decision trees, support vector machines, clustering algorithms, and statistical learning methods. These techniques and models enable a computer system to automatically learn patterns or representations from data and improve performance on a given task without being explicitly programmed with task-specific rules. Machine learning systems may operate in supervised, unsupervised, semi-supervised, reinforcement, or self-supervised learning paradigms, and may be designed to perform a wide range of tasks such as classification, prediction, generation, translation, anomaly detection, and optimization across various data modalities, including text, images, audio, video, and structured data.

As described herein, a “model” refers to a computational system, algorithm, or structured representation used with a machine learning system. Examples of models include machine learning models, neural networks, transformer-based architectures, generative models, reasoning models, agentic systems, probabilistic models, statistical models, or rule-based systems. Models may be designed to process input data and produce outputs, predictions, decisions, actions, representations, or generated content. Models may operate under various learning paradigms, including supervised, unsupervised, semi-supervised, reinforcement, or self-supervised learning, and may be configured to perform tasks such as classification, regression, recommendation, anomaly detection, generation, translation, summarization, planning, decision-making, or multi-step reasoning across a range of data modalities, including structured data, text, images, audio, video, and sensor data.

As discussed in detail below, the machine learning techniques disclosed herein may be provided to analyze transaction data (e.g., financial transaction data) across multiple entities and parties. Through use of federated learning, the techniques disclosed herein may identify patterns and behaviors that deviate from a standardized form of normalcy. For example, in a federated learning system deployed across multiple banks and payment processors, each institution may locally train a machine learning model on its own financial transaction data, such as account activity, transaction amounts, merchant categories, geographic locations, and device usage patterns. These LTMs may then be aggregated into a federated model that captures broader transactional patterns across institutions. By analyzing this federated model, the system can detect behaviors that deviate from established norms, such as an unusually high volume of low-value international transfers, sudden changes in spending patterns across linked accounts, or coordinated small-dollar purchases that align with known fraud typologies. Importantly, the system identifies these rare or anomalous patterns without requiring the institutions to share raw transactional data, thereby preserving privacy while improving the overall effectiveness of anomaly detection across the financial ecosystem.

The focus on rare-event anomalies is especially significant in the financial sector, where such events may indicate serious issues like fraud, money laundering, or other illicit activities. These rare events, while infrequent, can have substantial financial and reputational impacts on institutions and individuals involved.

The systems described can process complex, multi-dimensional data from various sources, including transaction histories, account information, and external data feeds. This comprehensive approach allows for a more nuanced and accurate identification of anomalous activities, even when they are deliberately disguised to appear normal.

By applying these advanced machine learning techniques, financial institutions and regulatory bodies can enhance their ability to safeguard financial systems, protect consumers, and maintain the integrity of financial markets. The dynamic nature of these systems also allows them to adapt to new types of financial products, emerging technologies, and evolving criminal tactics, ensuring ongoing effectiveness in anomaly detection.

Accessing and aggregating data into a single dataset propose technical, legal, and regulatory barriers, particularly for entities that desire to keep the data of their clients private or are compelled to so by law or regulatory regimes. Entities overwhelmingly desire to keep certain data private but at the same time have a facility to train models on disparate datasets to improve the model's ability to detect anomalies. Rather than have users share their data to train the models, method and techniques described herein travel the model to the data and train the models locally at the entities that control the data.

Some of the challenges with aggregating data into a single dataset to train models are because the data may not be centrally located, even within the same entity. Sorting, aggregating, and transferring data remotely to train a model would require significant bandwidth and computational resources from the processors and memories devices involved in transmitting and receiving large dataset.

In another example, regulatory and jurisdictional challenges, such as HIPPA or handling of Personally Identifiable Information (PII), financial account data, and jurisdictional constraints can limit or prohibit the transfer and storage of these data. In addition, wide prevalence of data breaches and ransomware attacks have resulted in more stringent data privacy and security protections. In yet another example, aggregating data may impact organizations moving to vendor cloud software-as-a-service (SaaS) solutions. For example, an institution, e.g., financial or medical, may desire to move data to the cloud. Data breaches can occur through these vendor cloud SaaS solutions. Institutions, such as financial institutions take a risk with new vendors and vendor solutions because data may not be stored at the institution.

Using the system and techniques disclosed herein, models are trained without copying, storing, or retaining the underlying data to the user devices that are training the models. The underlying data remains within the entities. The system also provides a diverse set of datasets to train models on new typologies, particularly where there are significant legal and or technical barriers to obtaining the data to train the models.

The system addresses those data challenges by using Federated Learning to solve these data challenges. In some implementations, the system disclosed herein may be implemented as a cloud platform (e.g., remote distributed computing resources) that enables multiple authorized contributors to share artificial intelligence (AI) models and those models, which are federated by the system across other authorized user devices.

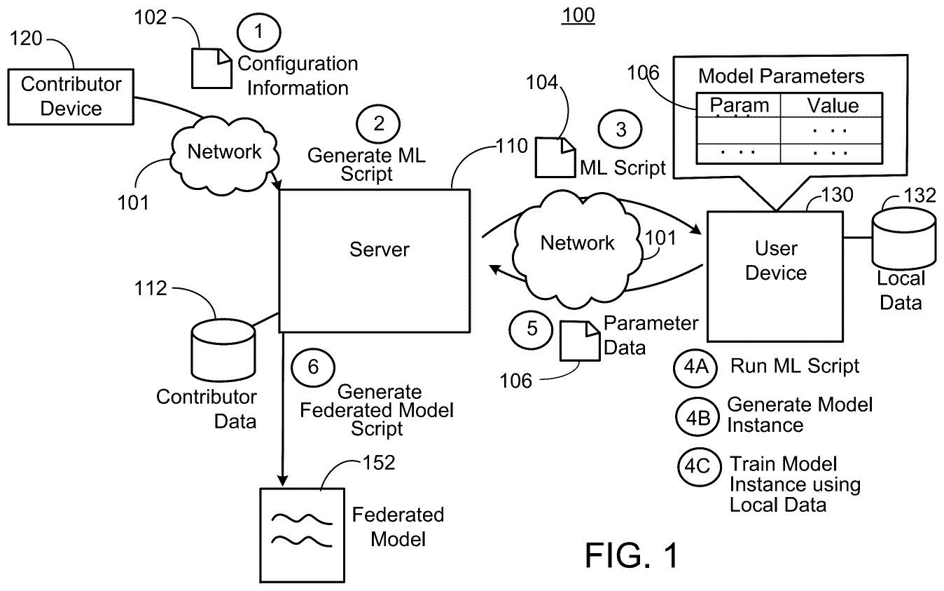

FIG. 1 illustrates an example of a system100 having a server 110 coupled to a user device 130 configured to federate one or more artificial intelligence models, such as one or more financial models. The system 100 includes a server 110 communicatively coupled over a network 101 to a contributor device 120 and a user device 130. Data may be exchanged between the contributor device 120 and the user device 130 over the network 101 and using the server 110.

For example, the contributor device 120 can produce configuration information 102 for generating a Model Training Script, e.g., ML script 104. In some implementations, configuration information 102 is transmitted from the contributor device 120 to the server 110. The server 110 uses the configuration information, along with any instructions therein, to generate the ML script 104. In some implementations, the configuration information 102 causes the contributor device 120 to generate the ML script 104 locally on the contributor device 120.

The configuration information 102 serves as a detailed specification for generating the ML script 104. Configuration information 102 may define not just the language but the specific architecture of the machine learning model to be instantiated on the user device 130. For instance, for a neural network, configuration information 102 may specify the number and types of layers (e.g., convolutional, recurrent, attention, dense layers), the activation functions for each layer, initialization strategies for weights, the optimizer algorithm (e.g., Adam, SGD), and the precise loss function. Furthermore, the configuration information 102 and the resulting ML script 104 may include instructions for data preprocessing and feature engineering to be performed by the user device 130 on its local data 132. These instructions ensure that the local data 132 is transformed into a format compatible with the model's input layer, and may involve steps like normalization, scaling, handling of missing values, encoding of categorical features, and selection of specific data subsets based on criteria. The ML script 104 thus provides a complete recipe for the user device 130 to generate a model instance (e.g., process 4B, FIG. 1) and train it (e.g., process 4C, FIG. 1).

The generated ML script 104 may be written in a suitable programming language, such as C+, C++, python script, R, that runs on the user device 130. Configuration information 102 may be written in a different programming language, such as a JSON file or set of instructions that can be implemented on the server 110. Configuration information is used to generate the ML script 104 at the server 110. In some implementations, the ML script 104 can be generated at the contributor device 120. The contributor data may include, in some implementations, requirement data. The requirement data can include parameters that indicate the type of data in the local data 132 is of interest. For example, contributor data may include parameters that are included with the ML script 104 and determine a subset of the local data 132 the model instance should train on, e.g., at process 4C.

In the example shown in FIG. 1, the server 110 receives the configuration information 102 from the contributor device 120, as illustrated in process 1. The configuration information 102 may be a file or instructions, such as JSON file, XML file, or set of instructions that can be implemented on the server 110. At process 2, the server 110 generates the ML script using the configuration information 102. The ML script 104, generated at the server 110, is transmitted over the network 101 to the user device 130, as illustrated by process 3.

Using the ML script, the user device 130 locally generates parameter data 106. The parameter data 106 includes one or more parameters associated with one or more values. For example, the parameter data 106 each given parameter among the one or more parameters has a discrete value associated with the given parameter. Once generated, the parameter data 106 can reside on the user device 130 as a file or data set.

In more detail, at process 4A, the user device 130 executes the ML script 104 locally. In response to executing the ML script 104, as demonstrated at process 4B, the user device 130 generates a model instance using instructions in the ML script 104. At process 4C, local data 132 is used to train the ML script 104 locally at the user device 130.

The local data 132 can include data that is locally stored at the user device 130, in some implementations. In another implementation, the local data 132 can be aggregated by the use device 130 from remote data that the user device 130 has an exclusive right to access. For example, account data from multiple jurisdictions to which the user device 130 is permitted to obtain from within a financial entity.

The parameter data 106 is generated when the local data 132 trains the ML script 104. For example, the parameter data 106 can represent values in a generalized model (gₘ) having original parameter values a, b, c, and represented by the generalized model gₘ(a, b, c). As illustrated at process 4C, the user device generates and outputs the parameter data 106, which can include the generalized model gₘ(a, b, c).

In some implementations, the user device 130 outputs the original parameter values a, b, c in the generalized model, gₘ. The ML script 102 may include the generalized model gₘ, parameter value limits, a number of parameters of the model, and the type of data upon which to train the generated model.

In some implementations, the parameter data 106 is an LTM trained on local data 132 using the model that was generated at process 4B. The output of the parameter data 106 are locally output parameter values m, n, o that correspond to changes in the generalized model gₘ as it trained on the local data 132 at the user device 130. Thus, locally output parameter values m, n, o can change according to the different data sets from a different set of local data. The different set of local data can originate from a second set of local data (not shown) that the user device 130 has access to or a second user device (e.g., 202, 202B, 202C) having access to its own local data. One or more of the original parameter values a, b, c are different from the local parameter values m, n, o.

In some implementations, the ML script 104 can include instructions for how local data 132 is processed or aggregated. For example, local data 132 can be aggregated a type of user account, from different user accounts, a same user account, or metrics indicating a type of user or a type of transaction, including from legal jurisdictions, e.g., from different states, regions, or countries. The data used to train the model may use account data related to demographics, geographic location, health-status, number of transactions, one or more numerical values in a set of transactions, currencies, and the like.

Parameter data 106, at process 5, is received via the network 101 at the server 110. The server 110 processes the parameter data 106. In some implementations, federating the parameter data 106 at the server 110 corresponds to processing the parameter data 106. The parameter data 106 (e.g., LTM), in some implementations, is federated by using an average weighted method, in which an average weight is applied across the parameter data 106. In some implementations, other LTMs from other user devices, or on the same user device, with different parameters can be included in the average weighting of LTMs.

When federating LTMs (e.g., parameter data 106 from FIG. 1) using the “average weighted method,” server 110 processes these LTMs by applying specific weights to each contributing LTM before averaging their parameters. The determination of these weights can be based on various criteria to optimize the quality of the federated model 152. For instance, weights may be proportional to the quantity of local data 132 used by the user device 130 to train its LTM, thereby giving more influence on models trained on larger datasets. In other instances, weights are reported local model performance metrics (e.g., accuracy, loss) if shared by the user devices in a privacy-preserving manner. Further, weights may also be determined based on the recency or version of the LTM contribution, a pre-defined trust score or reliability metric associated with the contributor device 120 or user device 130. In some other examples, uniform weighting is used if other criteria are not applicable. The server 110 then computes the weighted average of the corresponding parameters (e.g., neural network weights and biases) across all participating LTMs to form the parameters of the federated model 152.

The LTM contains weights and measures of the model parameters (e.g., parameters of gₘ) and does not contain local data 132. In some implementations, the parameter data 106 is federated by using a generator method where the parameter data 106 output from a plurality of user devices (e.g., 202A, 202B, 202C) is used to generate a synthetic dataset into a single dataset that is stored on the server 110. For example, server data 112 may be stored on the server. The server data 112 can be records uploaded by the user device 120 or another user device (not shown). The server data 112, in some implementations, can by synthetic data, or a combination of synthetic data and uploaded data.

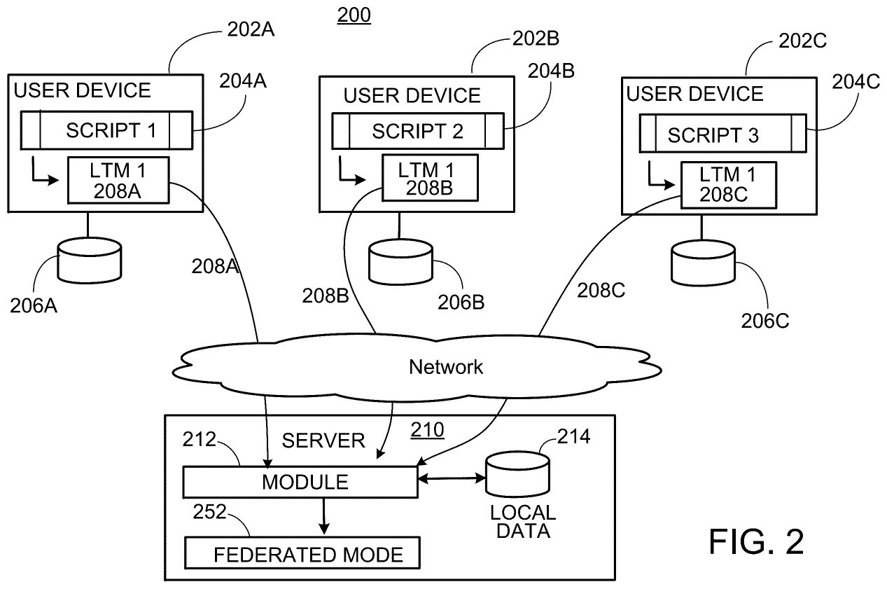

When the generator method is employed for federating parameter data 106, the server 110 utilizes received LTMs, which represent learned model parameters (e.g., weights and biases from local training on data 132), to generate a synthetic dataset. In some implementations, this synthetic dataset (e.g., part of or all of contributor data 112) is created by using the aggregated LTM parameters to train a dedicated model resident on the server 110. The resident model may be, for instance, a Generative Adversarial Network (GAN) or a Variational Autoencoder (VAE) which may be part of module 212 (FIG. 2). The LTMs, capturing aspects of the data distributions from diverse client devices, may serve as the basis for training this server-side generative model. Once trained, this server-side generative model produces synthetic data samples (feature vectors) that statistically mimic characteristics of the combined client data without containing or exposing any actual raw data (e.g., local data 132). This privacy-preserving synthetic dataset 112 is then used as the training corpus on the server 110 for the ML script 104 or a server-side equivalent, to generate the federated model 152. This process effectively creates a rich, diverse training set on the server without centralizing sensitive client data, improving the robustness and generalizability of the resulting federated model.

In some implementations, LTM parameters from parameter data 106 may be used more directly by the server 110 to sample from statistical distributions defined or informed by these parameters. In such implementations, the server 110 constructs the synthetic dataset 112 without training an intermediate generative model. The synthetic data generation process may be designed to ensure that the synthetic samples do not allow for the re-identification or reconstruction of individual records from any client's local data 132.

At process 6, the server 110 generates a federated model script (FMS). Using the parameter data 106, the FMS generates a federated model 152. The federated model 152, using the FMS, can be generated using the average weighted method, generator method, or a combination of the average weighted and generator methods. The federated model 152 includes federated parameter values x, y, z, where one or more of the values are different from the local parameter values m, n, o and original parameter values a, b, c. At process 6, when the federated model 152 is generate, process 1-6 have transformed the parameters of the generalized function gₘ in the ML script 104, such that the original parameter values a, b, c are transformed to the federated parameter values x, y, z without copying the local data 132 to the server 110 while training the model generated at the user device 130.

The parameter values (a, b, c; m, n, o; x, y, z) discussed herein are exemplary. It is understood that the generalized model gₘ may fewer or more parameters and the value of the parameters can positive, negative, real, or imaginary depending on the instructions in the ML script 102.

Advantageously, the federated model 152 is generated without storing or retaining any portion of the local data 132 at the server 110. As such, computational and storage resources of the server 110 are reduced. For example, because the configuration of the server 110, as disclosed herein, enables the federated model 152 to be generated with less burden on one or more processors (not shown) at the server 110 since the one or more processors do not receive, route, and segregate local data 132 from other data sources as the federated model 152 is generated. The server 110 generates the ML script 104, which is transmitted to the user device 130. One or more processors (not shown) and storage (not shown) at the user device 103 expend computational and storage resources locally, i.e., away from the server 110, as part of processes 1-6 in which the federated model 152 is generated. Power, bandwidth, and resource consumption at the server 110 are reduced, while handling or throughput of model generation is increased-without a corresponding increase in computer hardware components.

In some implementations, the server 110, at process 6, generates a “synthetic” dataset. The synthetic dataset, in some implementations, can be trained by the server 110 to generate synthetic parameters, a′, b′, c′. In some implementations, the parameter data 106, generated by the plurality of user devices, is trained on the server 110 to generate the synthetic dataset. In some implementations, federated model 152 is generated using the synthetic dataset. In some implementations, the synthetic parameters a′, b′, c′ can be used in combination with the parameter data 106 to generate federated model 152. Parameter data 106 can be electronically tagged so that it is associated with a given user device 130 or authorized user of the user device 130.

The federated model 152 can be output to a user device or user devices, such as the user device 130. The federated model 152 may be stored on the server 110 for later use. The federated model 152 may be indexed in storage of the server 110. Indexing facilitates the identification of the federated model 152 at the server 110, so that the federated model 152 can be accessed by another user device, corrected, or augmented. For example, numerical values of the federated parameter values x, y, z, might be updated.

Software is installed and runs on the user device 130, enabling the device to download the ML script 104 and perform processes 4A-4C. The software can include a web-based user interface for receiving user inputs. The software validates the installation to ensure authenticity of the user device. The software may run offline, e.g., in an environment where the user device 130 is not connected to the internet. When the user device is offline, validation of the software license is implemented when the user device 130 accesses the internet and has been authenticated. For example, the user device 130 may initiates a request to the server 110 to check and validate a user device's license. Credentials are created from the valid license and the credentials are locally stored at the user device 130 for subsequent validation checks. The validation checks may be at a predetermined frequency, such as weekly, monthly, or bi-monthly.

The software installed and running on the user device 130 generally enables the download of the ML script 104 and the execution of local training (e.g., processes 4A-4C, FIG. 1). The software is designed to provide a robust and secure execution environment. This environment may incorporate sandboxing techniques to isolate the operations of the ML script 104, thereby preventing it from accessing unauthorized system resources or data on the user device beyond the specifically designated local data 132. The software also manages local computational resources, such as CPU cycles, GPU utilization (if available), and memory allocation, during the model instantiation and training phases. This can include enforcing resource quotas or prioritizing tasks to ensure the stability of the user device and prevent the federated learning operations from unduly impacting other user activities or system functions. The software may also include components for secure local storage of credentials and the LTMs before their transmission.

FIG. 2 illustrates an example of a system 200 a server 210 coupled to plural user devices 202A-202C configured to federate one or more artificial intelligence models. The system 200 includes a server 210 that is connected to plural user devices 202A-202C through the network 101. Each of the plural user devices 202A, 202B, 202C has a machine learning (“ML) script 204A, 204B, 204C for generating an LTM 208A, 208B, 208C. In more detail, ML script 204A can cause user device 202A to generate LTM 208A using locally trained data 206A that user device 202A is authorized to access. For example, with reference to FIG. 1, the user device 202A may use the ML script 204A and local data 206A to generate parameter data 106 by executing processes 1-6, as described with respect to the system 100. In some implementations, the ML script 204A and configuration information 102 are generated at the user device 202A instead of generated at the server 110. Thus, in some implementations, the user device 202A performs processes executed by contributor device 120 and the user device 130.

The user device 202B can execute the ML script 204B for generating an LTM 208B using local data 206B. Similarly, using local data 206C, can execute the ML Script 204C that is trained on the using local data 206C to generate an LTM 208C. Accordingly, each of user device 202B and user device 202C, accessing their respective local data 206B, 206C, can generate parameter data 106 by executing their respective ML scripts 204B, 204C upon executing processes 1-6, as described with respect to the system 100. In accordance with user device 202A, in some implementations, the ML scripts 204B, 204C and configuration information 102 are generated at each of the user device 202B, 202C instead of generated at the server 110.

The module 212 receives one or more of LTMs 208A, 208B, and 208C from their respective user devices 202A, 202B, 202C. The server 210 has a module 212 for storing LTMs 208A, 208B, and 208C. Local data 214 resides on the server 210 and is coupled to the module 212. In some implementations, one or more of the LTMs 208A, 208B, and 208C are trained on the local data 214 residing the server 210 to generate the federated model 252. In some implementations, the LTMs 208A, 208B, and 208C are used to generate the federated model 252 without training on the local data 214. In some implementations, software running on the server 110 can be implemented as an application store enabling contributors to upload models, such as LTMs 208A, 208B, and 208C and permits authenticated users to access and download the models.

Using one or more of the LTMs 208A, 208B, and 208C, the federated model 252 can be generate using the average weighted method, generator method, or a combination of the average weighted and generator methods. The federated model 252 includes federated parameter values x, y, z, where one or more of the values are different from the local parameter values m, n, o and original parameter values a, b, c.

Advantageously, the federated model 252 is generated without storing or retaining any portion of the local data 206A, 206B, 206C at the server 210. As noted above, the configuration of the server 110 reduces computational and storage resources of the server 110. In addition, by implementing the processes 1-6, the user device 202A can train its own LTM 208A on the local data 206B of the user device 202B and/or the local data 206C of the user device 202C. In more detail, the user device 202B has access to local data 206B and the user device 202C has access to local data 206C.

Using a more detailed example, each of the user devices 202A, 202B, 202C can reside in different jurisdictions with different legal and compliance rules on handling, storing, and transferring local data 206A, 206B, 206C. For example, the federated model 152 could be directed towards detecting a type of fraud category, such as wire transfer fraud or Automated Clearing House (ACH) fraud, money laundering, or credit card skimming, or other types of banking and lending fraud. Within the broader categories of fraud, there may be rare event activities that might go undetected in other machine learning or artificial intelligence models because of the rare nature of the event.

The system 200 facilitates the generation of a federal model 252 that can detect the rare event by training on large amounts of data that is available through accessing the server 210 but not directly shareable among the user devices 202A, 202B, 202C. For example, if user device 202A resides within in a first legal jurisdiction where the rare event primarily occurs with cash transactions, the local data 206A will reflect cash transactions, which may have a denomination and frequency that are different from local data 206C, located in a second jurisdiction. Local data 206C has multiple credit card transactions that occur at a higher currency amounts than local data 206A, because various transactions in local data 206C are not cash-based transactions.

Local data 206B associated with user device 202B may be subject to laws and financial regulations of a third legal jurisdiction, where the type of rare event occurs in user accounts that also have investment accounts above a certain value. Local data 206A, 206B, 206C may be private or sensitive financial data having legal and regulatory hurdles that prevent data sharing among the user devices 202A, 202B, 202C. The system 200, as well as the methods and techniques described herein, enable the federated model 252 to generate, using the data controlled or accessible by each of the user device 202A, 202B, 202C residing in different jurisdictions.

The server 110, without accessing, storing, or processing local data 206A, 20, 206C, receives ML scripts 204A, 204B, 204C at the module 212. Thus, the server 110 receives the benefit of the ML scripts 204A, 204B, 204C without expending corresponding computational resources at the server 110. The local data 206A, 206B, 206C remains in the jurisdiction in which it originates, and the LTMs 208A, 208B, 208C, trained on the local data 206A, 206B, 206C, are output to the server 210.

Contributors contribute one or more models to the server 110. Contributors can contribute a package of models to server 110 (binary relevance). Contributors' models are subject to a vetting/validation process prior to being made available in the server 110. Software implemented on the server 110 may approve and/or reject models (e.g., ML scripts 104 or parameter data 106) that do not confirm model specifications or violate our terms of service. The server 110 enforces security of the system 100 by using security certificates.

Access to the server 110 is granted by permission. Thus, each of the contributor device 120 and user device 130 can established a connection with the server 110 after user credentials have been validated. In one example, the server 110 supports secure network connections with the server 110. As sch, all other connections (e.g., HTTP) are rejected at a firewall of the server 110.

In some implementations, beyond secure network connections (e.g., HTTPS) that protect data during transit between the user device 130 and the server 110, additional security measures can be applied specifically to the LTMs (parameter data 106). For example, before the LTMs are transmitted (e.g., process 5, FIG. 1), they can be encrypted on the user device using strong encryption algorithms (e.g., AES-256). Key management for this encryption may involve keys exchanged securely during the user device's authentication with the server, or keys managed by a trusted third party. Each LTM can be digitally signed by the originating user device using its private key. The server 110 can verify this signature using the user device's public key to ensure the LTM's authenticity and integrity. These measures provide an additional layer of security for the sensitive model parameters being exchanged.

Permissions can grant the user device 130 or contributor device 120 access to one or more user devices (not shown) to a single financial institution or a plurality of financial institutions. Permissions can enable the user device 130 or contributor device 120 to access data, and user devices authorized to copy, write, or store the data, from a plurality of financial institutions. In some implementations, permissions allow a user device 130 or contributor device 120 to access data, and user devices authorized to copy, write, or store the data, from a single financial institution. Authenticated users may include a global banking regulator, financial intelligence unit, other financial regulatory body or server 110 owner or operations. The authenticated user can be either a contributor, providing data to the contributor device 120, or a user, providing computational resources and data for the contributor. In some implementations, the contributor and user are the same entity.

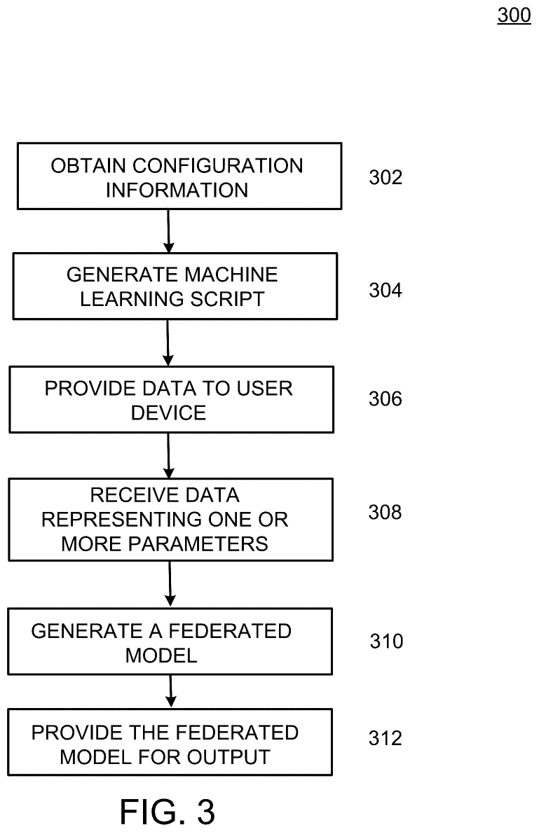

FIG. 3 is a flow chart illustrating an exemplary method 300 of generating a federated model 252. The method 300 beings at operation 302 where a computer system obtains configuration information. For example, the server 110 may obtain configuration information 102 from a contributor device 120. In some implementations, the contributor device 120 is also a user device, such as the user device 130.

At operation 304, the method 300 proceeds by generating machine learning script. The machine learning script can be generated at the contributor device or the server. The machine learning script includes instructions, generated from the configuration information, run the ML script on the user device.

The method 300 continues, where at operation 306, the system provides data to a user device. The instructions, included in the ML script, include commands for the user device 130 to generate a model instance at the user device. The user device generates the model instance and is authorized to store, write, or read local data. The generated model instance, trains the generated model on local data, as explained in processes 4A-4C. The model instance, using local data, outputs one or more parameters. The parameters are stored in one or more memory devices disposed on the user device.

Operation 308 proceeds by receiving, at the server, data representing the one or more parameters. Instructions in the configuration data or generated ML script 104 cause a processing device disposed on the user device to retrieve parameters stored in the one or more memory devices and transmit the parameters to the server. For example, a processing device at the user device 130 transmits the parameters from the user device 130 to the server 110.

A federated model is generated at operation 310. For example, an average weighted method may be used on the parameters, where an average weighting is applied across the parameter data. In some implementations, the parameter data can be federated by using a generator method. In this manner, parameter data 206 is output from a plurality of user devices (e.g., 202A, 202B, 202C) and is received at the server 110. A synthetic dataset into is generated into a single dataset that is stored on the server 110. A combination of both mathematical methods may be implemented.

In some implementations, federated models generated at the server 110 are validated and tested for model performance. This validation can employ several strategies. For instance, server 110 might may a held-out global validation dataset, which is part of the contributor data 112 or local data on server 110 if this data is specifically curated for validation (e.g., consisting of synthetic data not used for training the FM, or anonymized data from consenting parties). Additionally, or alternatively, the federated model 152 can be distributed to a subset of trusted user devices (e.g., device 130) for evaluation on their local data (e.g., local data 132), with only aggregated, anonymized performance metrics (e.g., for anomaly detection, metrics like precision, recall, F1-score, Area Under the ROC Curve (AUC-ROC), or Area Under the Precision-Recall Curve (AUC-PR)) being reported back to the server. When multiple candidates federated models are generated (e.g., one from the average weighted method and another from the generator method), server 110 may selects an overall federated Model (or “champion” model) based on superior performance against these predefined metrics on the chosen validation set(s). This selection may involve a specific decision logic, such as choosing the model with the highest F1-score or lowest false positive rate, depending on the application's requirements.

At operation 312, the system provides the federated model for output. The federated model can be output to the contributor device or to the user device. In some implementations, the federated model is output to the device from which the configuration information 102 is generated, which in some implementations can be the contributor device 120. In other implementations, the user device 130 generates the ML script 104 and receives the federated model as output from the server 110.

The output of the federated model 152 is a champion model. Optionally, operations 301 through 310 repeat as new users or contributors are added and if existing user devices train the ML script 104 with new datasets.

What is claim is:

1. A computer-implemented method, the method comprising:
obtaining, by a server, configuration information for a machine learning script;
generating, by the server, the machine learning script based at least in part on the configuration information;
providing, by the server, data representing the machine learning script to a user device, wherein the machine learning script, when executed by the user device, causes the user device to perform operations comprising:
training an instance of a machine learning model based on the machine learning script, and
identifying one or more parameters associated with the instance of the machine learning model;
receiving, by the server and from the user device, data representing the one or more parameters associated with the instance of the machine learning model;
generating, by the server, a federated model based at least in part on the received data representing the identified parameters; and
providing, by the server, the federated model for output.

2. The method of claim 1, wherein the machine learning script is configured to cause the user device to perform operations to train the instance of the machine learning model using data locally stored on the user device.

3. The method of claim 2, wherein the data representing the one or more parameters received from the user device does not comprise any identification information associated with the data locally stored on the user device.

4. The method of claim 1, wherein generating the federated model comprises applying an average weighting method to data representing parameters received from a plurality of user devices.

5. The method of claim 1, wherein generating the federated model comprises:
generating synthetic data based at least on the received data representing the identified parameters; and
generating the federated model based on the synthetic data.

6. The method of claim 1, wherein:
obtaining the configuration information comprises receiving, from a plurality of contributor devices, a submission comprising one or more model specifications; and
generating the machine learning script comprises defining at least a portion of the machine learning script based on submissions received from the plurality of contributor devices.

7. The method of claim 6, wherein the user device is not included in the plurality of contributor devices.

8. A system comprising:
one or more computing devices;
at least one storage device comprising instructions that, when executed by the one or more computing devices, causes the one or more computing devices to perform operations comprising:
obtaining configuration information for a machine learning script;
generating, by a server, the machine learning script based at least in part on the configuration information;
providing, by the server, data representing the machine learning script to a user device, wherein the machine learning script, when executed by the user device, causes the user device to perform operations comprising:
training an instance of a machine learning model based on the machine learning script, and
identifying one or more parameters associated with the instance of the machine learning model;
receiving, by the server and from the user device, data representing the one or more parameters associated with the instance of the machine learning model;
generating, by the server, a federated model based at least in part on the received data representing the identified parameters; and
providing, by the server, the federated model for output.

9. The system of claim 8, wherein the machine learning script is configured to cause the user device to perform operations to train the instance of the machine learning model using data locally stored on the user device.

10. The system of claim 9, wherein the data representing the one or more parameters received from the user device does not comprise any identification information associated with the data locally stored on the user device.

11. The system of claim 10, wherein generating the federated model comprises applying an average weighting method to data representing parameters received from a plurality of user devices.

12. The system of claim 8, wherein generating the federated model comprises:
generating synthetic data based at least on the received data representing the identified parameters; and
generating the federated model based on the synthetic data.

13. The system of claim 12, wherein:
obtaining the configuration information comprises receiving, from a plurality of contributor devices, a submission comprising one or more model specifications; and
generating the machine learning script comprises defining at least a portion of the machine learning script based on submissions received from the plurality of contributor devices.

14. The system of claim 13, wherein the user device is not included in the plurality of contributor devices.

15. At least one non-transitory computer-readable storage media comprising instructions that, when executed by one or more processors, causes the one or more processors to perform operations comprising:
obtaining configuration information for a machine learning script;
generating, by a server, the machine learning script based at least in part on the configuration information;
providing, by the server, data representing the machine learning script to a user device, wherein the machine learning script, when executed by the user device, causes the user device to perform operations comprising:
training an instance of a machine learning model based on the machine learning script, and
identifying one or more parameters associated with the instance of the machine learning model;
receiving, by the server and from the user device, data representing the one or more parameters associated with the instance of the machine learning model;
generating, by the server, a federated model based at least in part on the received data representing the identified parameters; and
providing, by the server, the federated model for output.

16. The computer-readable storage of claim 15, wherein the machine learning script is configured to cause the user device to perform operations to train the instance of the machine learning model using data locally stored on the user device.

17. The computer-readable storage of claim 16, wherein the data representing the one or more parameters received from the user device does not comprise any identification information associated with the data locally stored on the user device.

18. The computer-readable storage of claim 15, wherein generating the federated model comprises applying an average weighting method to data representing parameters received from a plurality of user devices.

19. The computer-readable storage of claim 15, wherein generating the federated model comprises:
generating synthetic data based at least on the received data representing the identified parameters; and
generating the federated model based on the synthetic data.

20. The computer-readable storage of claim 15, wherein:
obtaining the configuration information comprises receiving, from a plurality of contributor devices, a submission comprising one or more model specifications; and
generating the machine learning script comprises defining at least a portion of the machine learning script based on submissions received from the plurality of contributor devices, wherein the user device is not included in the plurality of contributor devices.
